(19) United States
(12) Patent Application Publication
(10) Pub. No.: US 2011/0094453 A1
(43) Pub. Date: Apr. 28, 2011

(54) IMPROVED APPARATUS AND METHOD FOR ASSESSING VISUAL LEARNING

(75) Inventor: Rebecca Burwell, Warren, RI (US)

(73) Assignee: BROWN UNIVERSITY, BROWN TECHNOLOGY PARTNERSHIPS, Providence, RI (US)

(21) Appl. No.: 12/919,167

(22) PCT Filed: Apr. 30, 2009
(86) PCT No.: PCT/US2009/042207

§ 371 Date: Nov. 30, 2010

(51) Int. Cl. A01K 15/02

(52) U.S. Cl. 119/712

(57) ABSTRACT

An improved test apparatus and method for assessing visual learning in mammals is provided. The stimuli presented to the mammal are disposed and arranged on the floor of the test apparatus instead of on the walls.

### FIELD OF THE INVENTION

The invention is in the field of cognitive neuroscience.

### BACKGROUND OF THE INVENTION

Psychologists and other learning and memory researchers employ a variety of behavioral tests using normal and pharmacologically impaired or lesioned animals, typically rats and mice, to assess the effect of various medical conditions, disease states, congenital and genetic defects, and drug-induced conditions and behaviors on learning and memory. Such tests include, for example, spatial and non-spatial delayed non-match (or match) to sample tests, sensory discrimination tests, one-trial item recognition tests, attentional tests (for example, the five choice serial reaction time task), and various perceptual identification tests. Spatial learning and navigation tests are often used with rats and mice as a model of learning and memory. Various testing apparatuses are employed to carry out these tests, for example the Barnes circular maze, the Morris water maze and the Olton radial arm maze. For visual learning, the two-choice visual discrimination test was originally developed for rats by Lashley. See Lashley, The mechanism of vision. I.A. Methods for rapid analysis of pattern-vision in the rat,” J. Genet. Psychol. 37: 453-60 (1930). Exemplary tests and apparatus are described in, for example, Aggleton, “One-Trial Object Recognition by Rats,” Quarterly J Exp Psychology 37B: 279-94 (1985); Robinson, et al., “Visual discrimination learning in the water maze: a novel test for visual acuity,” Behavioural Brain Research 119: 77-84 (2001); Gaffan and Eacott, “A computer-controlled maze environment for testing visual memory in the rat.” J. Neuroscience Methods 60: 32-37 (1995); Prusky et al., “Behavioral assessment of visual acuity in mice and rats,” Vision Research 40: 2201-09 (2000). In all of these tasks, the rodent is presented visual stimuli and trained to choose a “correct” stimulus by means of a food reward. How rapidly the rodent learns to discriminate the stimuli is measured. The rodent's brain may be implanted with a recording apparatus and its movements tracked. In the conduct of all of the foregoing tasks, the stimuli are presented in a vertical plane, on a wall or at the end of an “arm” or passage in a maze.

The foregoing and other tests employed in the field find utility in drug development and pharmaceutical studies, and in the study of cognitive deterioration and the basic science of cognitive processes. Acetylcholine-mediated neurotransmission plays an important role in learning and the progressive degeneration of this system is coincident with the progressive loss of cognitive deterioration found in Alzheimer's disease. See for example Robinson et al, “Visual acuity in the water maze: sensitivity to muscarinic receptor blockade in rats and mice, Behavioural Brain Research 151: 277-86 (2004). Neurodegenerative diseases such as Huntington's disease and treatments are studied using such tests. See for example, Pallier et al., “Pharmacological Imposition of Sleep Slows Cognitive Decline and Reverses Dysregulation of Circadian Gene Expression in a Transgenic Mouse Model of Huntington's Disease,” J. Neuroxcience 27(29): 7869-78 (2007). Another use of such tests is in the study of the effects of malnutrition on learning. See for example, Galler and Manes, “Gender Differences in Visual Discrimination by Rats in Response to Malnutrition of Varying Durations,” Developmental Psychobiology 13(4): 409-16 (1980).

Much of the behavioral work done in rats employs operant chambers (in which lights and noises are presented), various mazes (including dry land and water mazes), odors, or physical (3-dimensional) objects. Some researchers employ computer monitors to present vertical 2D stimuli in either operant chambers (see Bussey et al., “Discrimination of computer-graphic stimuli by mice: A method for the behavioral characterization of transgenic and gene knockout models,” Behavioral Neuroscience 115(4): 957-60 (2001) and Steckler and Sahgal, “Psychopharmacological studies in rats responding at touch-sensitive devices,” Psychopharmacology 118: 226-29 (1995)) or in swimming tasks (see Prusky, supra). The operant chamber approach is hampered by the need for the rat or mouse to learn a touch screen response which is difficult for them, and by the tendency of the rat or mouse to process the portion of the stimulus closest to the floor. The swimming task is an improvement in that swimming rats are looking upward and may pay attention to more of the stimulus. The disadvantage is that swimming tasks are labor intensive, cannot be easily automated, are not compatible with many research techniques, and are limited in the number of trials per day that can be presented. The physical 3D object tasks are limited by the difficulty developing different stimulus sets, are easily confounded with odor and tactile properties of the stimuli, and are time consuming to run due to the necessity of having to have multiples of the same objects to present.

Additional systems and methods for assessing behavior, including visual learning, are described in PCT Patent Publications WO 2005/001768 (Application No. PCT/US2004/018046) published Jun. 1, 2005; WO 2003/013429 (Application No. PCT/US2002/024879) published Feb. 20, 2003; WO 2002/093318 (Application No. PCT/US2002/015700) published Nov. 21, 2002; and WO 2002/092101 (Application No. PCT/US2002/015981) published Nov. 21, 2002.

For the foregoing reasons, there still remains a need in the art for an improved method and apparatus for assessing visual learning.

### SUMMARY OF THE INVENTION

The invention provides a method and an apparatus that exploits our observation that a rat or mouse standing on the floor tends to pay more attention to the bottom of a stimulus presented vertically on a wall of the apparatus. This observation led to an exploration of whether the mouse or rat would learn more rapidly if the stimuli were presented on the floor rather than on the wall of the test apparatus. Surprisingly, our results demonstrate that rats and mice learn significantly more rapidly (10 to 100 fold more rapidly) when presented floor-based stimuli in comparison to length of time it requires the rats and mice to learn when presented wall-based stimuli. This exponential increase in the speed with which the test animals learned to choose the correct stimuli was entirely unexpected.

Accordingly, in one aspect, the invention comprises an improved test apparatus for assessing visual learning in mammals in which an image of a visual stimulus is presented to the mammal. In the improved test apparatus of the invention, the image of the visual stimulus is presented on the floor of the test apparatus rather than on the wall of the test apparatus. The stimulus may be presented on the floor of the apparatus by any means.

In one embodiment, the image may be back-projected directly to the underside of a semi-transparent floor of the test apparatus by means of a projector. The floor of the test apparatus may be selected from a semi-transparent or translucent material suitable for back-projection and the projector may be disposed and arranged below the floor of the test apparatus.

The apparatus may further include reflection means, disposed and arranged in angular relation to the floor of the test apparatus so as to reflect the image onto the floor of the test apparatus. Any suitable means of projecting or reflecting the image of the stimulus on the floor of the test apparatus may be employed. One such means is a mirror.

In another embodiment, the floor may be composed of a transparent material (for example glass or clear Plexiglas) and the stimuli may be presented on the bottom surface of the transparent material by any suitable means, for example, by means of a paper sheet onto which the stimuli are reproduced and demountably attached to the bottom surface of the transparent floor material. The floor-presented stimuli can be seen by the test animal because of the transparency of the floor material. Alternatively, the test apparatus having a floor made of transparent material may be placed directly onto a LCD monitor displaying the stimuli. In both these embodiments, the need for a projection apparatus to project the image of the stimuli onto the floor is eliminated.

In another embodiment, the floor may be composed of an opaque material and images of the stimuli can be projected onto the floor of the test apparatus from above. For example, the floor may be made of a white or light colored Plexiglas, a light-hued wood material (ash for example), or any material painted a light hue so that the images of the stimuli can be projected onto it from above the test apparatus and be seen by the test animal.

The improved apparatus of the invention is suitable for testing visual discrimination of mammals including especially mice, rats and other rodents.

Exemplary mammalian behaviors or abilities that can be tested or assessed include the examination of working memory, reference memory, perception, and attention. The shape of the operant chamber is unimportant. Any shaped chamber, enclosure, maze, or test apparatus can be modified so that the tasks to be performed by the mammal are presented on the floor instead of onto the wall. Such modifications are well within the level of skill in the art.

Many tasks conducted in operant chambers can be adapted for the floor projection. Exemplary are (1) the five-choice serial reaction time task used to study attention; (2) the delayed matching (or non-matching) to position test used to study spatial working memory; (2) the delayed matching (or non-matching) to stimulus test used to study working memory for individual items; (4) the various types of complex discrimination tasks that use lights, tones, and noises; and (5) tests of visual acuity and contrast sensitivity that use visual psychophysical stimuli in the known and art recognized operant chambers and mazes employing wall presented tasks.

Further, many tasks that use physical objects can be readily adapted to employ the floor projection discovery of the invention. In this type of apparatus, small toys or everyday objects are used and the stimuli are presented in a Plexiglas box. Examples of cognitive tests employing these types of stimuli include (1) the two-choice discrimination tasks of all types; (2) the delayed matching (or non-matching) to sample test; (3) the familiarity, novelty, oddity tests in which the mammal must choose the stimulus that is new or different; and (4) the various types object-place associations tests. In addition, the attentional set-shifting test, which employs three dimensional stimuli can readily be adapted to use two dimensional stimuli projected onto the floor of the operant chamber. One of ordinary skill in the art can easily make any adaptations required to construct an operant chamber in which the stimuli are projected onto the floor of the chamber rather than onto a wall.

In another embodiment, many navigational tasks usually conducted in dry land mazes can be adapted for the floor-projection maze of the invention. The skilled artisan can readily adapt Kesner's cheese board (Kesner, Farnsworth, & DiMattia, 1989), the Barnes maze (Barnes, 1979), the Morris Water Maze (Morris, 1984), or the 8-radial arm maze (Olton and Samuelson, 1976) and its variants the 4-arm radial or plus maze, the T-maze, and the Y-maze so that the stimuli are floor-based rather than wall-based. The types of tasks that can be assessed employing such improved apparatuses include, inter alia, serial position tasks, spatial alternation tasks, navigational tasks of all types, distance discrimination tasks and object place association tasks.

In one embodiment, the exploratory test apparatus of the invention has a floor measuring 32 by 32 inches and four opaque walls measuring 32 by 18 inches extending vertically upward from the floor as in the typical known exploratory maze, operant chamber or test enclosure. The actual measurements of the test enclosure are unimportant, as long as the enclosure is large enough to permit the test animal free movement but small enough so that the test animal does not tire before attempting the task. The floor is made of a material such that images of objects can be reflected or projected onto the floor surface from outside of the maze or chamber. The material employed may be any material as long as it permits projection of the image onto it. For example, any translucent or semi-transparent material may be employed. Clear Plexiglas or glass may be employed in combination with a material that permits back projection. In this embodiment, a mirror is arranged in angular relation to the bottom surface of the chamber floor in such a manner that light striking the mirror is reflected upward and impinges the bottom surface of the chamber's floor. An LCD projector outside the chamber is used to direct images of the stimuli to the mirror, which reflects the images onto the chamber floor. Because the floor is made of a material that allows light to pass through it, the image appears on the upper surface of the floor inside the maze or chamber itself. The mirror may be affixed, either permanently or demountably, to the edge of the bottom surface of the floor using coupling means such as one or more hinges or clamping bolts.

In another embodiment, the test apparatus of the invention has a floor measuring 44 by 56 inches and four opaque walls measuring 42 by 54 inches. Images are projected directly to the semi-transparent maze floor from below rather than reflected by mirror, eliminating the need for the reflecting mirror.

In another embodiment, the exploratory maze or test apparatus of the invention may be placed directly on an LCD or other monitor or screen. In this case, images are visible directly below a transparent maze floor, eliminating the need for the reflecting mirror and for a semi-transparent floor.

In another aspect the invention comprises an improved method for assessing visual learning in mammals in which a test apparatus having a floor is employed. In this aspect, the improvement comprises presenting an image of the stimulus used to assess visual learning on the floor of the test apparatus. Any one of the apparatus described above, for example, may be employed in the improved method of the invention.

### DESCRIPTION OF THE DRAWINGS

FIG. 1 is an illustration of a test apparatus of the invention showing the floor projection of the task to be performed by the animal to be tested as further described in Example 1.

FIG. 2 is an illustration of the stimuli for the two choice discrimination task performed as described in Example 1.

FIG. 3 is a graphic illustration of the results of the two-choice discrimination dice task described in Example 1.

FIG. 4 is an illustration of a floor-displayed terrain location association task that can be conducted using the improved test apparatus of the invention.

FIG. 5 is an illustration of exemplary transformations of the terrain location association task that can be tested with the floor-display based apparatus and method of the invention.

FIG. 6 is an illustration of a contrast sensitivity and acuity test that can be conducted using the improved test apparatus of the invention.

### DETAILED DESCRIPTION

The invention is exemplified using an exploratory maze as the test apparatus in which one of many possible tests may be conducted. In this example, the conducted test is a “dice task” two-choice discrimination task.

### Example 1

### Dice Task

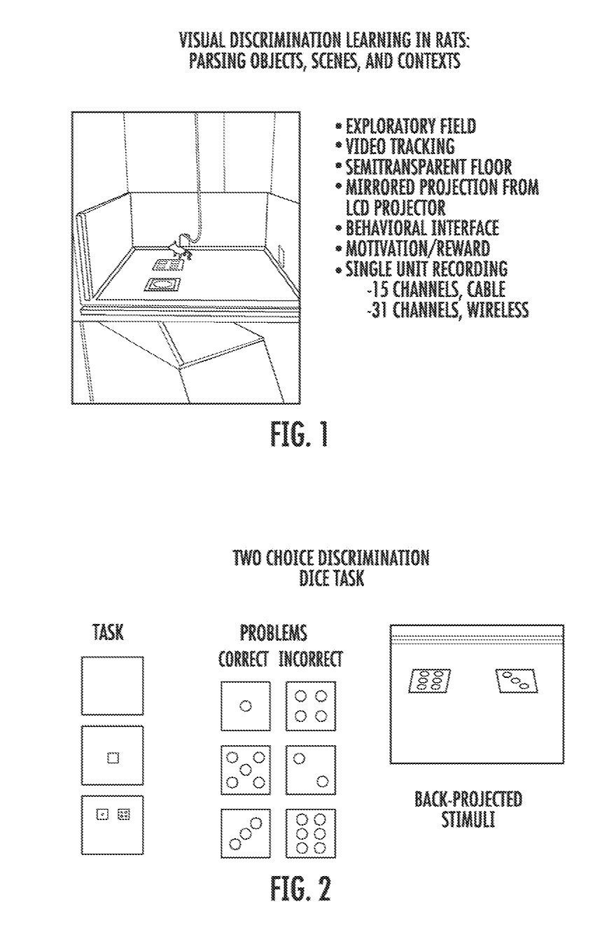

This two-choice discrimination task uses 2-dimensional (2D) stimuli back-projected to the floor of an exploratory maze by an LCD or DLP projector. The stimuli resemble playing dice, hence the designation “the dice task.” Any 2D visual stimuli can be presented in this manner, and any number of behavioral contingencies can be implemented. The Two-Choice Discrimination task can be conducted in a number of ways, as one of skill in the art is aware, but in this example it was conducted as follows. The test apparatus has a floor measuring 32 by 32 inches and four opaque walls measuring 32 by 14 inches extending vertically upward from the floor as in the typical test apparatus, except that the floor was made of a semi-transparent material such that images of objects are reflected onto the floor surface from outside the test apparatus, and a mirror was angularly affixed to the bottom surface of the apparatus floor in such a manner that light striking the mirror was reflected upward and onto the bottom surface of the chamber's semi-transparent floor. An LCD projector outside the chamber was used to direct images of the stimuli to the mirror, which reflects the images onto the apparatus floor. Between trials, a blank homogenous grey floor was presented. A trial was initiated when the rat or mouse was near a food port in one of the walls of the apparatus. A square, indicating a fixation location, was projected onto the floor using the LCD projector. (See FIG. 2, left hand panel.) The rat or mouse enters the fixation location from a specified direction and remains still facing the direction in which the choice stimuli will appear. When the animal has remained in the target location for a specified time, the LCD projector projected the stimuli onto the floor of the chamber by means of the reflecting mirror. (See FIG. 1.) The animal signals a choice by approaching one of the two stimuli. A correct choice was rewarded by a tone signaling food availability. An incorrect choice terminated the trial.

Three problems were presented to a cohort of six rats, one rat at a time, in the test apparatus of the invention. As illustrated in FIG. 2, the rats had to choose between a die with one dot and a die with four dots, a die with five dots and a die with two dots, and a die with three dots and a die with six dots. The one-dot, five-dot and three-dot dies were the correct choice. The four-dot, two-dot, and six-dot dies were the incorrect choice.

The projection of visual stimuli was controlled by a custom MedPC program using MedAssociates behavioral control hardware (MedAssociates, Inc. Burlington, Vt.). The position of the rat or mouse was tracked by the Plexon CinePlex tracking system (Plexon, Inc., Dallas, Tex.). Both MedAssociates and CinePlex systems communicate via a third system, the Plexon MAP data acquisition system (Plexon, Inc., Dallas, Tex.). The CinePlex system and the MedAssociates system communicate via both Plexon and MedAssociates hardware interfaces. All Plexon and MedAssociates equipment were operated in accordance with the manufacturer's instructions. A custom MatLab software program running on the MAP system permitted communication between the CinePlex tracking system and the MedAssociates behavioral control system. CinePlex tracked the location of the rat or mouse using contrast, LED lights, or color in two-dimensional (x-y) coordinates and communicated the x-y coordinates to a MatLab program running on the MAP system. The custom MatLab program evaluated the location of the animal and signaled the MedPC program when the animal was in a location relevant to the behavioral task. Based on the location of the animal, the MedAssociates program controlled the visual stimuli as well as auditory stimuli, and the delivery food or liquid reward. The MedPC program also recorded trial by trial information. Information recorded includes, for example, trial type, latencies to approach the fixation, latencies to approach the stimulus, whether the trial was correct or not.

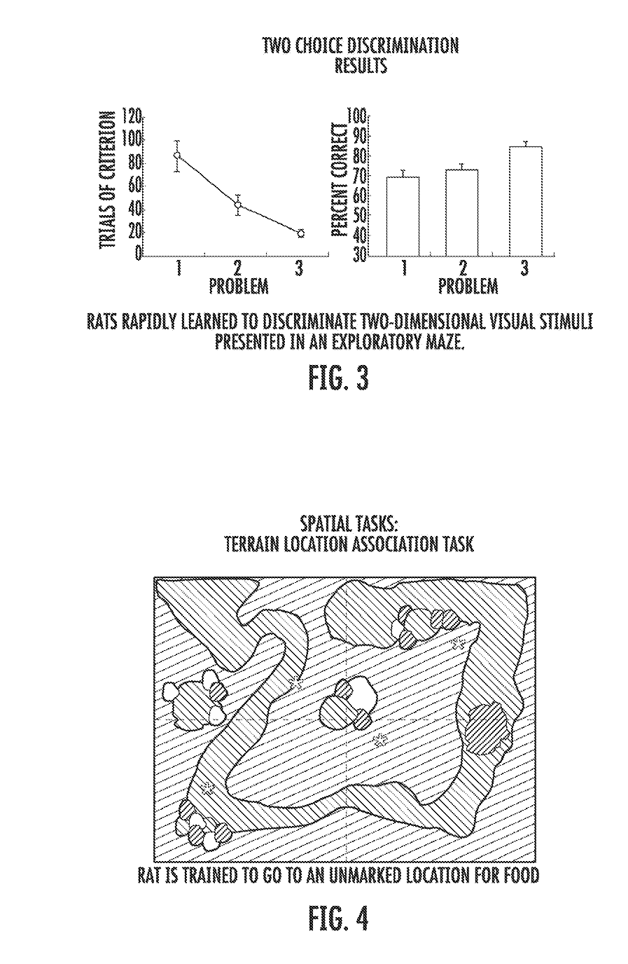

The results are illustrated in FIG. 3, which demonstrates that rats rapidly learned to discriminate two-dimensional visual stimuli. The mean number of trials needed to choose the correct stimulus decreased from 90 in the first problem to 50 in the second problem to 20 in the third problem and the mean percentage correct increased from below 70 percent to almost 85%. In comparison, when a similar test was conducted with the visual stimuli presented vertically on the wall of the apparatus rather than on the floor, rats required hundreds of trials (see Gaffan and Eacott, supra, 1995, FIG. 7) or thousands of trials (see Minini and Jeffery, “Do rats use shape to solve “shape discriminations”?” Learning & Memory 13: 287-97 (2006)) to reach a criterion of learning.

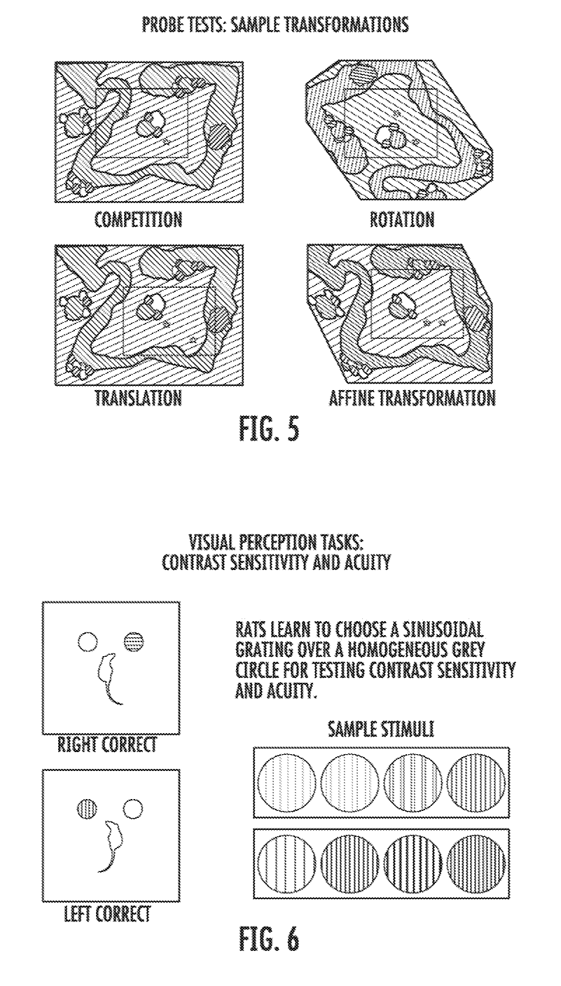

Referring now to FIGS. 4-5, there is shown an alternative test that can be employed in the apparatus and method of the invention. In this test, the floor-based stimulus is a topographical map-like two dimensional representation encompassing an area that is four times larger than the entire floor of the test apparatus. The map, or “terrain” is characterized by features that could serve as landmarks in a navigational task. In this spatial test, the rodent is trained to go to an unmarked location for food in each of the four quadrants of the larger map. Then, with reference to FIG. 5, the way in which the animal is processing the terrain and its features for navigation can be probed by presenting transformations of the terrain interspersed with training trials. For example, after training on all four quadrants, a portion of the quadrant that includes two trained locations could be presented (FIG. 5, Competition). It would be of interest to determine whether the animal's behavior indicates that the trained locations are recognized. If recording neuronal correlates of place in the apparatus, it would be of interest to observe any changes in spatial correlates. Next the animal could be trained in the portion of the maze shown in FIG. 5, Competition, with the grey asterisk marking the hidden rewarded location. Then successive probes could examine behavioral and neuronal correlates of rotation, translation, affine, and other transformations of the terrain.

Referring to FIG. 6, there is illustrated another embodiment of the improved apparatus and method of the invention, a floor-based contrast sensitivity and acuity test, which represents a measure of visual perception. In this task, rats are taught to choose a circle grating over a homogeneous grey circle. Rats readily learn to go to the grating over the grey circle. The contrast of the grating can then be reduced until the rat can no longer perceive it as indicated by chance performance (FIG. 6, upper panel of stimuli). The same approach can be taken with the frequency of the gratings. In this manner, a contrast sensitivity threshold and a spatial frequency threshold can be obtained. This approach could also be used to assess perceptual learning and plasticity associated with perceptual learning.

All patents, publications, and other references cited herein are hereby incorporated by reference. Although the invention has been particularly described with reference to certain preferred embodiments, skilled artisans appreciate that changes in form and details may be made without departing from the scope of the appended claims.

1. In a test apparatus for assessing visual learning in mammals in which an image of a visual stimulus is presented to the mammal said test apparatus having a floor, the improvement comprising presenting said image of the visual stimulus on the floor of the test apparatus.

2. The apparatus according to claim 1 wherein said image is presented on the floor of the test apparatus by means of a projector.

3. The apparatus according to claim 2 wherein said projector is disposed and arranged above the floor of the test apparatus.

4. The apparatus according to claim 2 wherein the floor of the test apparatus is selected from a transparent, semi-transparent or translucent material and said projector is disposed and arranged below the floor of the test apparatus.

5. The apparatus according to claim 4, said apparatus further including a reflection means, disposed and arranged in angular relation to the floor of the test apparatus so as to reflect said image onto the floor of the test apparatus.

6. The apparatus according to claim 5 wherein said reflection means comprises a mirror.

7. The apparatus according to claim 1 wherein the mammal is a rodent.

8. The apparatus according to claim 2 wherein the mammal is a rodent.

9. The apparatus according to claim 3 wherein the mammal is a rodent.

10. The apparatus according to claim 4 wherein the mammal is a rodent.

11. The apparatus according to claim 5 wherein the mammal is a rodent.

12. The apparatus according to claim 7 wherein the rodent is a rat or a mouse.

13. The apparatus according to claim 8 wherein the rodent is a rat or a mouse.

14. The apparatus according to claim 9 wherein the rodent is a rat or a mouse.

15. The apparatus according to claim 10 wherein the rodent is a rat or a mouse.

16. The apparatus according to claim 11 wherein the rodent is a rat or a mouse.

17. In a method for assessing visual learning in mammals in which a test apparatus having a floor is employed, the improvement comprising presenting an image of the stimulus used to assess visual learning on the floor of the test apparatus.

18. The improved method according to claim 17 in which the image is presented on the floor of the test apparatus by mean of a projector.

19. The improved method according to claim 18 wherein said projector is disposed and arranged above the floor of the test apparatus.

20. The improved method according to claim 18 wherein the floor of the test apparatus is selected from a transparent, semi-transparent or translucent material and said projector is disposed and arranged below the floor of the test apparatus.

21. The improved method according to claim 20, said apparatus further including a reflection means, disposed and arranged in angular relation to the floor of the test apparatus so as to reflect said image onto the floor of the test apparatus.

22. The improved method according to claim 21 wherein said reflection means comprises a mirror.

23. The improved method according to claim 17 wherein the mammal is a rodent.

24. The improved method according to claim 18 wherein the mammal is a rodent.

25. The improved method according to claim 19 wherein the mammal is a rodent.

26. The improved method according to claim 20 wherein the mammal is a rodent.

27. The improved method according to claim 21 wherein the mammal is a rodent.

28. The improved method according to claim 22 wherein the mammal is a rodent.

29. The improved method according to claim 23 wherein the rodent is a rat or a mouse.

30. The improved method according to claim 24 wherein the rodent is a rat or a mouse.

31. The improved method according to claim 25 wherein the rodent is a rat or a mouse.

32. The improved method according to claim 26 wherein the rodent is a rat or a mouse.

33. The improved method according to claim 27 wherein the rodent is a rat or a mouse.

34. The improved method according to claim 28 wherein the rodent is a rat or a mouse.
